(19) United States
(12) Patent Application Publication
(10) Pub. No.: US 2025/0345943 A1
(43) Pub. Date: Nov. 13, 2025

(54) END EFFECTOR FOR TORPEDO CAR CAPPING ROBOT AND CAPPING METHOD THEREOF

(71) Applicant: Baoshan Iron & Steel Co., Ltd., Shanghai (CN)

(72) Inventors: Ruimin Wu, Shanghai (CN); Chen Shen, Shanghai (CN); Tianmao Huang, Shanghai (CN); Changhong Ye, Shanghai (CN); Wei Dong, Shanghai (CN); Guowei Sun, Shanghai (CN); Yabei Li, Shanghai (CN); Huimin Sun, Shanghai (CN); Saidan Yang, Shanghai (CN)

(21) Appl. No.: 18/878,849

(22) PCT Filed: Jun. 25, 2023
(86) PCT No.: PCT/CN2023/102073

§ 371 Date: Dec. 24, 2024

(30) Foreign Application Priority Data
Jun. 27, 2022 (CN) 202210738223.2

(51) Int. Cl. B25J 9/16; B25J 15/06; B25J 19/00; C21B 3/10

(52) U.S. Cl. CPC B25J 9/1697; B25J 15/0625; B25J 19/0079; C21B 3/10

(57) ABSTRACT

An end effector for a torpedo car capping robot and a capping method thereof. which effector and method belong to the field of robot control. The end effector at least comprises: a pickup and release unit, a buffer unit, a heat preservation cover distance measurement unit, an end effector structure protection unit and a pneumatic execution unit. The capping method comprises: by means of a heat preservation cover visual system, identifying the center of a heat preservation cover at the current position to be subjected to picking up, feeding back the center to a robot system, and a pickup center position of an end effector moving to the position right above the center of the heat preservation cover; by means of a numerical value which is fed back by a heat preservation cover distance measurement unit, driving the robot system to descend with the end effector and pick up the heat preservation cover; and a tank opening visual system identifying the current direction of a tank opening of a torpedo car, feeding back data to the robot system, guiding the robot system to move to the position above the tank opening, and releasing the heat preservation cover, so as to complete a capping operation. A robot is automatically guided to perform accurate capping operation on a tank opening of a torpedo car, thereby ensuring the safety of an operation device and an operated object during the whole operation process.

### TECHNICAL FIELD

The present invention relates to the technology of an end effector of a robot for capping a tank opening of a torpedo car in the molten iron transportation link of the iron and steel industry, and more specifically, to an end effector for a torpedo car capping robot and a capping method thereof.

### BACKGROUND

In the iron and steel metallurgical process, molten iron transportation is mainly undertaken by a torpedo car.

At present, in the molten iron transportation link, the torpedo car completes the operation of pouring molten iron and returns to the blast furnace to wait for receiving molten iron, and the process reaches about 5 hours.

Due to the fact that the tank opening of the current torpedo car has no covering device, the hot air in the tank is directly in contact with the ambient atmosphere, causing pollution emissions, and the temperature drop in the tank is serious, causing energy waste for the subsequent molten iron process.

At present, the thermal insulation cover designed for the torpedo car (as shown in FIG. 1) is mostly transported from the ground to the top of the tank opening of the torpedo car by manual use of an electric hoist to perform a capping operation.

Usually, the thermal insulation cover 1 for this type of use is mainly composed of two parts: a main structure 2 and thermal insulation cotton 3. A flat iron plate is set in the middle of the main structure 2, and multiple lifting methods can be provided for the operation. The thermal insulation cotton 3 is a whole-cut circle, usually composed of glass fiber cotton, and the main structure 2 and the insulation cotton 3 are tied by high-temperature resistant iron wire.

Because workers need to stand close to the torpedo car to work, operation scenarios of the extremely high temperature, dust and splashing of molten steel around the torpedo car pose safety risks such as burns. At the same time, there is a large height difference between the operator and the tank opening of the torpedo car, and the status of the tank opening and the status of capping cannot be observed, which is unreliable in terms of safety and efficiency.

In order to complete the capping operation of the torpedo car more efficiently, industrial robots can be used to replace manual operations, and the relevant robot end effectors should also be developed as soon as possible.

The Chinese invention patent application with the application publication date of Feb. 8, 2017 and the application publication number of CN 106378790A discloses a robot suction cup device, including a suction cup assembly, a positioning guide sleeve sleeved in the suction cup assembly, and a suction cup with one end fixed in the suction cup assembly and connected to the positioning guide sleeve; the suction cup assembly includes a gas path joint with a through hole, and a shell sleeved on the positioning guide sleeve; and the gas path joint is threadedly connected to the suction cup joint. This device does not cause radial displacement and deflection during high-speed picking, and has good centering performance; the flexible vacuum suction cup is radially limited, so that the object does not shake during high-speed handling; the elastic buffer of the flexible suction cup is used, and the safety performance is good. However, because the technical solution is designed for high-speed handling and stacking, the suction cup used is made of rubber, which lacks high-temperature protection and cannot meet the application requirements in all scenarios. The device only has a single suction cup, and the weight of the object being picked up is limited. From a structural analysis, after the suction cup device is installed on the end flange of the robot, additional longitudinal-depth movement range expansion is not provided, and only handling near the range of the robot body can be achieved.

The Chinese invention patent with the authorization announcement date of Feb. 15, 2019 and the authorization announcement number CN106514690B discloses “a robot tooling”, including a clamp support used for providing a tooling installation connector, and further including a driving system and three grabbing handles arranged around the cylindrical center line; the driving system is installed on the clamp support, is connected with the three grabbing handles, and drives the three grabbing handles to do folding or unfolding motion so as to achieve grabbing or releasing of workpieces; and the driving system drives the three grabbing handles to move in radial direction around the center line on a plane vertical to the center line so that the three grabbing handles can be folded or unfolded to grab or release the workpieces, the grabbing faces of the grabbing handles are in fit with the surfaces of the workpieces, and contact between the grabbing handles and the workpieces is surface shape contact when the workpieces are grabbed. When the robot tooling grabs the workpieces, the grabbing faces and the workpiece surfaces are in surface shape contact, and therefore the reliability in the grabbing process is better improved. However, because the designed handling object is the compressor in the air conditioner, and the designed clamping claw structure is only applicable to a cube of a certain volume, for the operation object at which the present invention is targeted (a capping operation of the torpedo car), the operation task cannot be completed.

At the same time, in the technical solutions of the above two patents, no relevant sensors or devices are set to locate and detect the picked up objects.

### SUMMARY

An objective of the present invention is to provide an end effector for a torpedo car capping robot and a capping method thereof, which can automatically guide the robot to accurately pick up a thermal insulation cover, locate the position of a tank opening of the torpedo car, and then guide the robot to accurately perform a capping operation for the tank opening of the torpedo car again.

The technical solution of the present invention is to provide an end effector for a torpedo car capping robot, and the end effector includes:
1) a picking and releasing unit, configured to pick up and release a thermal insulation cover; including: a suction cup for picking up and releasing the thermal insulation cover, and a retractable air pipe for providing compressed gas and a guide rod for fixing the retractable air pipe; where the retractable air pipe is fitted into the guide rod, so that the retractable air pipe can only move in an axial direction of the guide rod;
2) a buffer unit, configured to connect the suction cup with a component mounting plate on the end effector; including: a buffer support rod that can make a compression stroke between the suction cup and the component mounting plate and a buffer support rod bushing that increases a contact stroke between the buffer support rod and the component mounting plate; where an L stopper is fixed above the buffer support rod bushing; the buffer support rod is distributed in four holes on the component mounting plate, and the four holes are arranged in a square or rectangular shape; the diameter of the four holes on the component mounting plate is slightly larger than the diameter of the buffer support rod; and a detection device is arranged on the component mounting plate;
3) a thermal insulation cover distance detection unit, configured to detect a relative distance between the thermal insulation cover and the component mounting plate; including: a laser rangefinder for performing detection; where the component mounting plate has a rectangular hole in a distance monitoring area of the laser rangefinder, so that the detection beam of the laser rangefinder can be directed directly below the component mounting plate;
4) an end effector structure protection unit, configured to detect the compression amount of the buffer support rod; including: a photoelectric sensor for performing detection; a group of photoelectric sensors includes two, and the two photoelectric sensors are fixedly installed between the fixing bracket and the component mounting plate; the two photoelectric sensors included in a single group are arranged up and down, and are fixedly installed in an axial direction of the end effector;
5) a pneumatic actuator unit, configured to control a flow direction of the compressed gas inside the suction cup; including: a two-position three-way solenoid valve and double-head two-group connectors for performing air path control; where an air inlet of the two-position three-way solenoid valve is connected to the compressed gas, and two air outlets are respectively connected to the double-head two-group connectors, one of the double-head two-group connectors is connected to magnetic force generating ports of the four suction cups, and the other double-head two-group connector is connected to magnetic force eliminating ports of the four suction cups, so as to achieve the purpose of controlling the suction cups through the two-position three-way solenoid valve;
6) an end effector protective cover shell unit, configured to provide closed protection for the components set inside the end effector; including: an angle steel frame for reinforcing a frame structure and a sealing plate for enclosing components at the front end of the end effector, and a suction cup protective cover shell to prevent direct collision with the suction cup during movement;
7) a heat dissipation unit, configured to block high-temperature exhaust gas and dust to be outside the end effector; including: a gas distribution block for performing gas distribution and a retractable and bendable air pipe nozzle; where the connected air path is distributed by the gas distribution block and then connected to the air pipe nozzle respectively, and the high-temperature exhaust gas and dust in the working environment are blocked to be outside the end effector by the compressed gas released by the air pipe nozzle.

Further, the end effector further includes a thermal insulation cover/tank opening visual system, which is used to identify a center position of the thermal insulation cover/tank opening to be picked up at the pick-up position, and feed back to the robot system; including: a thermal insulation cover visual camera and/or a tank opening visual camera.

Specifically, the suction cup can be a permanent magnetic pneumatic suction cup or an electromagnetic suction cup.

Preferably, the buffer support rod and the suction cup are connected and fixed by a ball hinge, so that when the thermal insulation cover is tilted, the suction cup is given a twisting amount, so as to better complete the picking operation.

Specifically, the buffer support rod bushing is fixedly installed between the component mounting plate and the buffer support rod; and the function is as follows: without increasing the thickness of the component mounting plate, the buffer support rod is fitted into the buffer support rod bushing fixed in the hole of the component mounting plate, so that the contact area between the buffer support rod and the component mounting plate is increased, the shaking of the buffer support rod caused by external force during operation can be reduced, and the weight of the end effector is minimized.

Specifically, in the end effector structure protection unit, the detection device fixed on the component mounting plate is a photoelectric sensor.

Further, the suction cup protective cover shell in the end effector protective cover shell unit has a lower end whose horizontal plane is higher than the horizontal plane of the bottom surface of the suction cup at the extreme pressing position.

The technical solution of the present invention further provides a capping method of the end effector for a torpedo car capping robot, at least including the following steps:
1) After the end effector moves to the top of the thermal insulation cover, the center of the thermal insulation cover at the current pick-up position is identified by the thermal insulation cover visual system and fed back to the robot system, and then the picking center of the end effector moves to be directly above the center of the thermal insulation cover;
2) The robot system is driven by using the value fed back by the thermal insulation cover distance detection unit to descend with the end effector and pick up the thermal insulation cover. In this process, if a measurement deviation of the value fed back by the thermal insulation cover distance detection unit occurs and causes the descent stroke to be too large, thereby endangering the mechanical structure of the end effector, the end effector structure protection unit monitors the compression amount of the buffer unit at all times, and when the compression amount reaches the critical compression amount, information is sent out and the robot system is driven to stop descending and lift upwards;
3) When the end effector moves to the top of the tank opening of the torpedo car, the tank opening visual system identifies a current position of the tank opening of the torpedo car, and feeds back data to the robot system, and after the robot system is guided to move to the top of the tank opening of the torpedo car, the capping operation is completed by releasing the thermal insulation cover.

Furthermore, the capping method specifically includes the following steps:
1) After the end effector moves to the top of the thermal insulation cover, the thermal insulation cover visual camera is activated, and takes a photo of the thermal insulation cover and identifies to find a center position; thereafter, the thermal insulation cover visual camera feeds back coordinates of the center position of the thermal insulation cover to the robot system;
2) After the robot system moves the end effector to be directly above the thermal insulation cover, the suction cup executes a magnetization instruction; the laser rangefinder in the end effector starts to measure a distance between the current end effector and the thermal insulation cover to be picked up; thereafter, the end effector executes a descending instruction according to the feedback value;

During this process, if an error occurs in the feedback value, resulting in an excessive descent stroke, the buffer support rod installed on the suction cup starts to compress, and when the compression amount reaches a preset value, the L-shaped stopper installed on the upper end of the buffer support rod bushing triggers the photoelectric sensor signal, a stop-descending instruction is fed back to the robot system, and the picking operation of the thermal insulation cover is completed by default, and the thermal insulation cover is lifted to the process position height;

In this case, the laser rangefinder measures again; because the value fed back by the laser rangefinder remains constant after the picking is successful, the value is used to determine whether the end effector has completed the picking operation of the thermal insulation cover;
3) The end effector that picks up the thermal insulation cover is moved to the process position above the tank opening of the torpedo car; then, the tank opening visual camera takes a photo of the tank opening of the torpedo car and identifies to find a center position; then, the tank opening visual camera feeds back coordinates of the center position of the tank opening of the torpedo car to the robot system; after the robot system moves the end effector to the capping process position above the tank opening of the torpedo car, the suction cup executes a demagnetization instruction, so that the thermal insulation cover is released above the tank opening of the torpedo car, thereby completing the capping operation;
4) During the entire operation, the air pipe nozzle connected to the heat dissipation unit releases the compressed gas into the end effector, so that the external high-temperature exhaust gas and dust cannot enter the end effector through the holes or gaps, thereby protecting the components.

Compared with the prior art, the advantages of the present invention are as follows:
1. The technical solution of the present invention can automatically complete the precise picking of the thermal insulation cover, efficiently transport and accurately complete the capping operation for the tank opening of the torpedo car, and can improve the efficiency of performing capping for the torpedo car and reduce the danger of manual operation;
2. Due to the adoption of the automatic positioning mode, the robot can be automatically guided to accurately pick up the thermal insulation cover, and after locating the position of the tank opening of the torpedo car, the robot is guided again to accurately perform the capping operation for the tank opening of the torpedo car, so that the precise locating and smooth progress of the entire operation process are ensured, and the safety of the operating equipment and the object being operated during the entire operation process are also ensured;
3. The end effector of the robot system of the present invention is used, so that the capping operation can be efficiently performed for the tank opening of the torpedo car in a high-quality manner, the efficiency of capping is sped up and safety and reliability are improved while the manual operation is replaced, and the end effector of the robot system can be beneficially used in the metallurgical industry.

### BRIEF DESCRIPTION OF DRAWINGS

FIG. 1 is a schematic structural diagram of a thermal insulation cover;

FIG. 2 is an overall schematic diagram of an end effector according to the present invention;

FIG. 3 is a schematic diagram of an internal structure of an end effector according to the present invention;

FIG. 4 is a schematic diagram of performing a picking operation for a thermal insulation cover according to the present invention;

FIG. 5 is a schematic diagram describing that a thermal insulation cover has been picked up according to the present invention;

FIG. 6 is a schematic diagram of an internal buffer unit after compression according to the present invention; and

FIG. 7 is a schematic diagram of a capping operation according to the present invention.

### DETAILED DESCRIPTION OF EMBODIMENTS

The present invention is further described below with reference to the accompanying drawings.

The present invention provides an end effector for a torpedo car capping robot, which is used to perform an operation for a thermal insulation cover of a tank opening of a torpedo car.

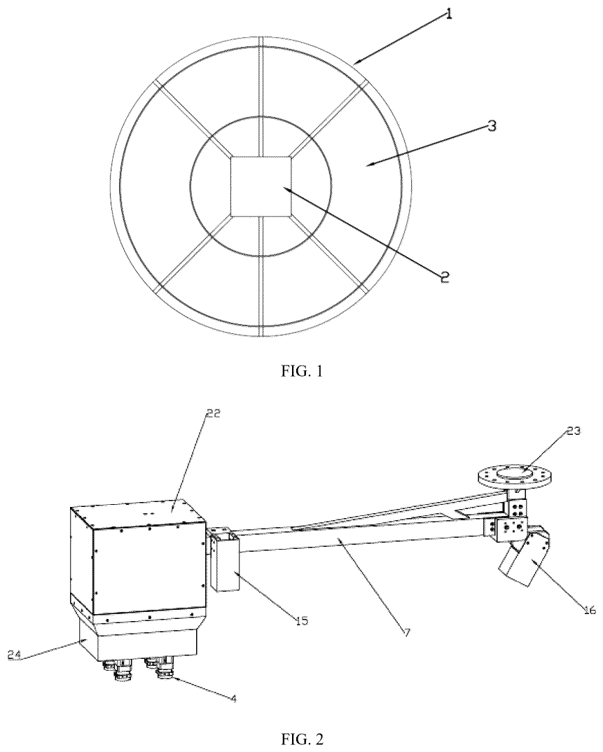

As shown in FIG. 1, a thermal insulation cover 1 includes: a picking structure 2 and thermal insulation cotton 3.

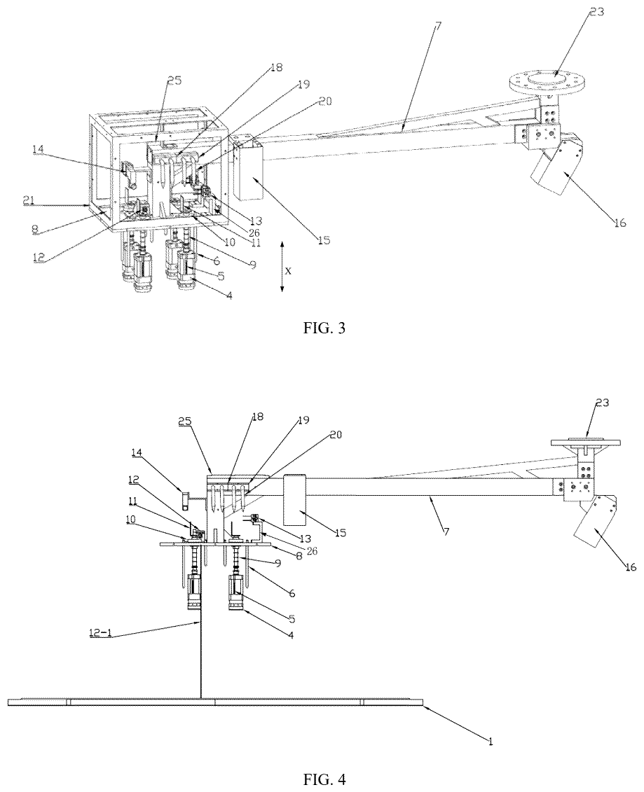

Referring to FIGS. 2 and 3, an end effector 7 provided by the present invention is connected to the end of the robot by means of a flange mounting surface 23, and the components in the end effector 7 communicate with the robot system through an IO-LINK controller 25.

With reference to FIGS. 2 and 3, the end effector 7 provided by the present invention includes:
1) A picking and releasing execution unit is configured to pick up and release the thermal insulation cover 1.

The picking and releasing execution unit includes: a permanent magnetic pneumatic suction cup 4 for picking up and releasing the thermal insulation cover 1, and a retractable air pipe (not shown) for providing compressed gas and a guide rod 6 for fixing the retractable air pipe. The retractable air pipe and the guide rod 6 both extend in the X direction shown in FIG. 3. The compressed gas passes through the retractable air pipe and then enters the inside of the end effector 7, so that the high-temperature exhaust gas and dust outside cannot pass into the inside of the end effector 7, which plays a role in protecting components.

At the same time, the retractable air pipe is fitted into the guide rod 6, so that the retractable air pipe can only move in the axial direction of the guide rod 6 (that is, the X direction shown in FIG. 3). An electromagnetic sensor 5 is installed on the permanent magnetic pneumatic suction cup 4, and can monitor the working state of the permanent magnetic pneumatic suction cup 4 in real time. The type of suction cup used to pick up and release the thermal insulation cover 1 is not limited in the present application, provided that the suction cup can pick up and release the thermal insulation cover 1, such as the permanent magnetic pneumatic suction cup 4 shown in this embodiment, or an electromagnetic suction cup.

Preferably, the retractable air pipe is made of high temperature resistant material.

It should be noted that the number of permanent magnetic pneumatic suction cups 4 is not limited in present application, for example, may be four shown in this embodiment of the present application, or may be three.
2) A buffer unit is configured to connect the permanent magnetic pneumatic suction cup 4 and a component mounting plate 8 on the end effector 7.

The buffer unit includes: a buffer support rod 9 that can make the permanent magnetic pneumatic suction cup 4 and the component mounting plate 8 have a compression stroke, and an L-shaped stopper 11 is fixed above the buffer support rod 9.

For example, the buffer support rods 9 are distributed in four holes on the component mounting plate 8, and the four holes are arranged in a square or rectangular shape. The buffer support rod 9 and the permanent magnetic pneumatic suction cup 4 are connected and fixed by a ball hinge. In this way, when the thermal insulation cover 1 is tilted, the permanent magnetic pneumatic suction cup 4 is given a twisting amount, so as to better complete the picking operation.

The buffer unit further includes: a buffer support rod bushing 10 for increasing a contact stroke between the buffer support rod 9 and the component mounting plate 8. The buffer support rod bushing 10 is fixedly installed between the component mounting plate 8 and the buffer support rod 9. Without increasing the thickness of the component mounting plate 8, the buffer support rod 9 is fitted into the buffer support rod bushing 10 fixed in the hole of the component mounting plate 8, so that the contact area between the buffer support rod 9 and the component mounting plate 8 is increased, the shaking of the buffer support rod 9 caused by external force during operation is reduced, and the weight of the end effector 7 is minimized.

Exemplarily, the diameter of the four holes on the component mounting plate 8 is slightly larger than the diameter of the buffer support rod 9. For example, the diameter of the buffer support rod 9 is set to 20 mm, and the diameter of the hole can be set to 24 mm, but limitation is not set thereto. The buffer support rod bushing 10 can be set to a step shape, extending along the X direction shown in FIG. 3 and passing through the hole. In order to fix the buffer support rod bushing 10 in the hole, the diameter of the buffer support rod bushing 10 above the hole is larger than the diameter of the hole, and the diameter of the buffer support rod bushing 10 below the hole is smaller than the diameter of the hole, and the buffer support rod bushing 10 below the hole is connected to the buffer support rod 9.

It should be noted that the number of holes on the component mounting plate 8 is not limited in the present application, provided that the number of holes on the component mounting plate 8 is consistent with the number of permanent magnetic pneumatic suction cups 4, for example, may be four shown in this embodiment of the present application, or may be three.
3) A thermal insulation cover distance detection unit is configured to detect a relative distance between the thermal insulation cover 1 and the component mounting plate 8 (for example, the distance shown in 12-1 in FIG. 4).

The thermal insulation cover distance detection unit includes: a laser rangefinder 12 for performing detection.

The laser rangefinder 12 is fixedly installed between a fixing bracket 26 and the component mounting plate 8.

The component mounting plate 8 has a rectangular hole in a distance monitoring area of the laser rangefinder 12, so that the detection beam of the laser rangefinder 12 can be directed directly below the component mounting plate 8.
4) An end effector structure protection unit is configured to detect a current compression amount of the buffer support rod 9.

The end effector structure protection unit includes: a photoelectric sensor 13 for performing detection.

Two photoelectric sensors 13 are assembled in a group, and are fixedly installed between a fixing bracket 26 and the component mounting plate 8. The fixing bracket 26 is in an inverted C shape, so that a certain distance between the photoelectric sensor 13 and the component mounting plate 8 can be kept.

Two photoelectric sensors in a single group are arranged up and down, and are installed and fixed in an axial direction of the end effector 7 (that is, the X direction shown in FIG. 3). When the L-shaped stopper 11 moves up to trigger the photoelectric sensor 13 located below, the robot gets feedback indicating that a descent stroke is too large at this time. When the L-shaped stopper 11 continues to move up to trigger the photoelectric sensor 13 located above, the robot forces to stop descending (refer to FIG. 5), so as to better protect the main structure of the end effector 7.
5) A pneumatic actuator is configured to control a flow direction of compressed gas inside the permanent magnetic pneumatic suction cup 4.

The pneumatic actuator includes: a two-position three-way solenoid valve 14 for performing gas path control and double-head two-group connectors.

An air inlet of the two-position three-way solenoid valve 14 is connected to the compressed gas, and two air outlets are respectively connected to double-head two-group connectors (not shown in the figure), one of the double-head two-group connectors is connected to magnetic force generating ports of the four permanent magnetic pneumatic suction cups 4, and the other double-head two-group connector is connected to magnetic force eliminating ports of the four permanent magnetic pneumatic suction cups 4, so as to achieve the purpose of controlling the permanent magnetic pneumatic suction cup 4 through the two-position three-way solenoid valve 14.

When the permanent magnetic pneumatic suction cup 4 needs to execute a magnetization instruction, the two-position three-way solenoid valve 14 supplies the compressed gas connected to the air inlet to the double-head two-group connector connected to the magnetic force generating ports of the four permanent magnetic pneumatic suction cups 4, so that the permanent magnetic pneumatic suction 4 is magnetized. When the permanent magnetic pneumatic suction cup 4 needs to execute a demagnetization instruction, the two-position three-way solenoid valve 14 supplies the compressed gas connected to the air inlet to the double-head two-group connector connected to the magnetic force eliminating ports of the four permanent magnetic pneumatic suction cups 4, so that the permanent magnetic pneumatic suction cup 4 is demagnetized.
6) An end effector protective cover shell unit is configured to provide closed protection for components set inside the end effector 7.

The end effector protective cover shell unit includes: an angle steel frame 21 for reinforcing a frame structure and a sealing plate 22 for enclosing the components at the front end of the end effector 7, and a suction cup protective cover shell 24 for preventing direct collision with the permanent magnetic pneumatic suction cup 4 during movement. The horizontal plane of the lower end of the suction cup protective cover shell 24 is higher than the horizontal plane of the bottom surface of the permanent magnetic pneumatic suction cup 4 at the extreme pressing position. With this design, when the permanent magnetic pneumatic suction cup 4 is at the extreme pressing position, the horizontal plane of the lower end of the suction cup protective cover shell 24 is higher than the position of the permanent magnetic pneumatic suction cup 4 at this time, so that the thermal insulation cover 1 sucked by the permanent magnetic pneumatic suction cup 4 at this time is located below the suction cup protective cover shell 24, effectively preventing the deformation of the thermal insulation cover 1.
7) A heat dissipation unit is configured to block high-temperature exhaust gas in the working environment to be outside the end effector 7.

The heat dissipation unit includes: a gas distribution block 19 for distributing the air path and an air pipe nozzle 20 for performing an air blowing operation.

The total air path is divided into two after entering the end effector 7, one of which is supplied to the pneumatic actuator unit for the two-position three-way solenoid valve 14 to control the permanent magnetic pneumatic suction cup 4, and the other is supplied to the heat dissipation unit for blocking the high-temperature exhaust gas in the working environment to be outside the end effector 7.

The connected air path is dispersed by the gas distribution block 19 and then connected to the air pipe nozzles 20 respectively. Relying on the compressed gas released by the air pipe nozzle 20, the high-temperature exhaust gas and dust in the working environment are blocked to be outside the end effector 7. At the same time, the air pipe nozzle 20 is made of flexible material and can be bent and stretched, so as to facilitate the blowing of high-pressure gas to every corner of the end effector 7.

It should be noted that the number of air pipe nozzles 20 is not limited in the present application, for example, may be four shown in this embodiment, or may be three.

The end effector 7 further includes a thermal insulation cover/tank opening visual system for identifying a center position of the thermal insulation cover/tank opening at the current pick-up position and feeding back to the robot system; and includes: a thermal insulation cover visual camera 15 and/or a tank opening visual camera 16.

In practical application, in order to simplify the system structure and spare parts types, the thermal insulation cover visual camera 15 and the tank opening visual camera 16 can use the same type of visual camera. If corresponding definitions and distinctions are made in the control program, the thermal insulation cover visual camera 15 and the tank opening visual camera 16 can also use the same visual camera to achieve the function reuse of “one machine, two uses” of the visual camera.

The present invention further provides a capping method of the end effector for a torpedo car capping robot. The method is described in detail with reference to FIGS. 4 to 7, including the following steps:
1) The end effector 7 is moved to the process position above the thermal insulation cover 1 (referred to as the process position, the same below), the thermal insulation cover visual camera 15 installed on the end effector 7 takes a photo of the thermal insulation cover 1 and identifies to find a center position, and feeds back coordinates to the robot system, and the robot carries the end effector 7 to move to be directly above the thermal insulation cover 1; that is, the center point of the rectangle or square where the four permanent magnetic pneumatic suction cups 4 installed on the component mounting plate 8 are distributed coincides with the center point of the thermal insulation cover 1 in the vertical direction (that is, the X direction shown in FIG. 3).
2) Referring to FIGS. 4 and 5, the two-position three-way solenoid valve 14 switches the air path supply to a magnetic force generation channel; that is, at this time, the four permanent magnetic pneumatic suction cups 4 generate magnetic force; thereafter, the laser rangefinder 12 measures the current relative distance between the end effector 7 and the thermal insulation cover 1 (refer to the number 12-1 shown in FIG. 4), and this distance is converted into the relative distance between the adsorption surface of the permanent magnetic pneumatic suction cup 4 and the thermal insulation cover 1; the end effector 7 descends by the measured distance and completes the operation of picking up the thermal insulation cover 1.

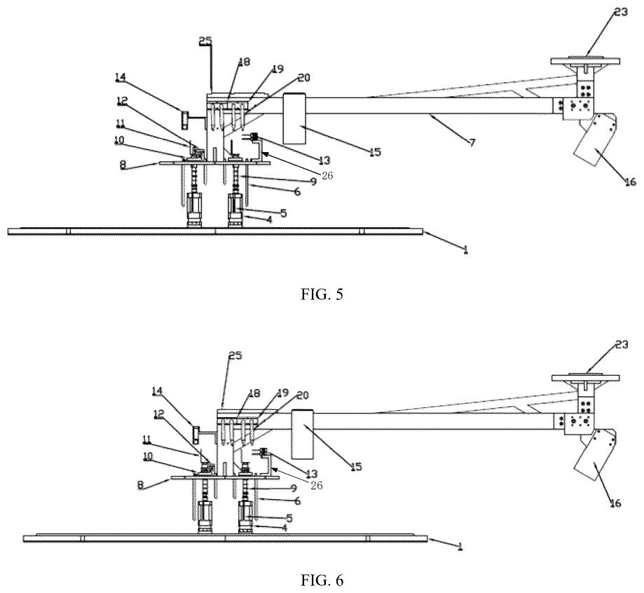

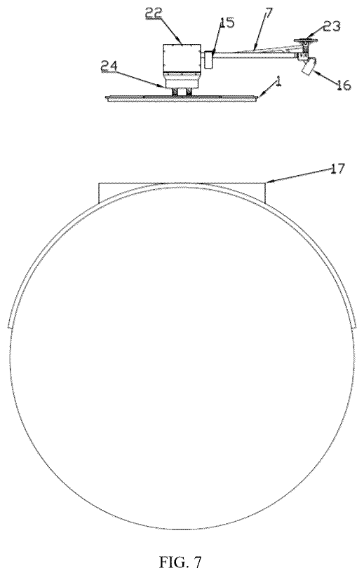

In this process, referring to FIG. 6, if there is a deviation in the measurement value of the laser rangefinder 12, leading to an excessive descent stroke, the buffer support rod 9 fixed to the permanent magnetic pneumatic suction cup 4 moves upward. When the error value is large and the upward movement of the buffer support rod 9 increases, the L-shaped stopper 11 fixed on the buffer support rod bushing 10 also moves with the buffer support rod 9 during this process. When the upward movement of the L-shaped stopper 11 triggers the photoelectric sensor 13, the robot receives signal feedback and stops the descent of the end effector 7 to protect the main structure of the end effector 7.
3) After completing the picking operation, the end effector 7 returns to the process position. At this time, the laser rangefinder 12 measures again. When the end effector 7 is in the state of picking up the thermal insulation cover 1, the measured value of the laser rangefinder 12 should be a fixed value. When the numerical feedback result is equal to the fixed value, it is determined that the picking operation of the thermal insulation cover 1 has been completed currently. When the numerical feedback result is much greater than the fixed value, it is determined that the thermal insulation cover 1 is lost or the picking operation has failed currently.
4) Referring to FIG. 7 and with reference to FIG. 6, after the end effector 7 moves to the top of a tank opening 17 of the torpedo car, the compressed gas of the total gas path is supplied to a gas distribution block 19, and then blown out through an air pipe nozzle 20 in a blowing device 18. The blown compressed gas can block the high-temperature exhaust gas emitted from the top of the tank opening 17 of the torpedo car to be outside the end effector 7. A tank opening visual camera 16 takes a photo of the tank opening 17 of the torpedo car and identifies to find a center position, and feeds back coordinates to the robot system, and then the end effector 7 moves to be directly above the tank opening 17 of the torpedo car, that is, at this time, the center of the thermal insulation cover 1 is facing the center of the tank opening 17 of the torpedo car, so that it can ensure that the thermal insulation cover 1 does not deviate or capping is not failed, and the two-position three-way solenoid valve 14 switches the gas path supply to the magnetic force disappearance channel; that is, at this time, the four permanent magnetic pneumatic suction cups 4 lose the magnetic force, and the thermal insulation cover 1 is immediately dropped onto the tank opening 17 of the torpedo car, and the capping operation is completed. In summary, in the capping device and the capping method of the present invention, the steps of manually lifting the thermal insulation cover from the ground and then performing capping for the torpedo car are replaced, and while using the automated capping device of the present invention to replace the steps, the sampling efficiency and safety reliability are accelerated. Therefore, the capping device and capping method can be used beneficially in the iron-making industry.

In addition, in the technical solution of the present invention, a thermal insulation cover distance detection unit is provided on the end effector, the position and distance of the thermal insulation cover can be measured in real time and accurately, to find the center position of the thermal insulation cover and feedback the coordinates, thereby ensuring the safety of the operating equipment and the object being operated during the entire operation. The present invention can be widely used in the design and manufacturing field of molten iron transportation operation devices in the iron and steel industry.

Ordinary technicians in this technical field should realize that the above embodiments are only used to illustrate the present invention, and are not used as a limitation of the present invention. As long as they are within the scope of the essential spirit of the present invention, changes and modifications to the above embodiments will fall within the scope of the claims of the present invention.

1. An end effector of a robot for capping for a torpedo car, wherein the end effector comprises:
1) a picking and releasing unit, configured to pick up and release a thermal insulation cover; comprising: a suction cup for picking up and releasing the thermal insulation cover, and a retractable air pipe for providing compressed gas and a guide rod for fixing the retractable air pipe; wherein the retractable air pipe is fitted into the guide rod, so that the retractable air pipe can only move in an axial direction of the guide rod;
2) a buffer unit, configured to connect the suction cup with a component mounting plate on the end effector; comprising: a buffer support rod that can make a compression stroke between the suction cup and the component mounting plate and a buffer support rod bushing that increases a contact stroke between the buffer support rod and the component mounting plate; wherein an L-shaped stopper is fixed above the buffer support rod bushing; the buffer support rod is distributed in four holes on the component mounting plate, and the four holes are arranged in a square or rectangular shape; the diameter of the four holes on the component mounting plate is slightly larger than the diameter of the buffer support rod; and a detection device is arranged on the component mounting plate;
3) a thermal insulation cover distance detection unit, configured to detect a relative distance between the thermal insulation cover and the component mounting plate; comprising: a laser rangefinder for performing detection; wherein the component mounting plate has a rectangular hole in a distance monitoring area of the laser rangefinder, so that a detection beam of the laser rangefinder can be directed directly below the component mounting plate;
4) an end effector structure protection unit, configured to detect a compression amount of the buffer support rod; comprising: a photoelectric sensor for performing detection; wherein a group of photoelectric sensors comprises two, and the two photoelectric sensors are fixedly installed between a fixing bracket and the component mounting plate; the two photoelectric sensors in a single group are arranged up and down, and are fixedly installed toward an axis direction of the end effector;
5) a pneumatic actuator unit, configured to control a flow direction of the compressed gas inside the suction cup; comprising: a two-position three-way solenoid valve and double-head two-group connectors for performing air path control; wherein an air inlet of the two-position three-way solenoid valve is connected to the compressed gas, and the two air outlets are respectively connected to the double-head two-group connectors, one of the double-head two-group connectors is connected to magnetic force generating ports of the four suction cups, and the other double-head two-group connector is connected to magnetic force eliminating ports of the four suction cups, so as to achieve the purpose of controlling the suction cups through the two-position three-way solenoid valve;
6) an end effector protective cover shell unit, configured to provide closed protection for components set inside the end effector; comprising: an angle steel frame for reinforcing the frame structure and a sealing plate for enclosing the components at the front end of the end effector, and a suction cup protective cover shell to prevent direct collision with the suction cup during movement; and
7) a heat dissipation unit, configured to block high-temperature exhaust gas and dust to be outside the end effector; comprising: a gas distribution block for performing gas distribution and a retractable and bendable air pipe nozzle, wherein the connected air path is dispersed through the gas distribution block and then connected to the air pipe nozzle respectively, the compressed gas released by the air pipe nozzle blocks the high-temperature exhaust gas and dust in the working environment to be outside the end effector.

2. The end effector of a robot for capping for a torpedo car according to claim 1, wherein the end effector further comprises a thermal insulation cover/tank opening visual system used for identifying a center position of the thermal insulation cover/tank opening at the pick-up position, and feeding back the center position to the robot system; comprising: a thermal insulation cover visual camera and/or a tank opening visual camera.

3. The end effector of a robot for capping for a torpedo car according to claim 1, wherein the suction cup is a permanent magnetic pneumatic suction cup or an electromagnetic suction cup.

4. The end effector of a robot for capping for a torpedo car according to claim 1, wherein the buffer support rod and the suction cup are connected and fixed by a ball joint.

5. The end effector of a robot for capping for a torpedo car according to claim 1, wherein the buffer support rod bushing is fixedly installed between the component mounting plate and the buffer support rod.

6. The end effector of the robot for capping a torpedo car according to claim 1, wherein, in the end effector structure protection unit, the detection device fixed on the component mounting plate is a photoelectric sensor.

7. The end effector of a robot for capping for a torpedo car according to claim 1, wherein the suction cup protective cover shell in the end effector protective cover shell unit has a lower end whose horizontal plane is higher than the horizontal plane of the bottom surface of the suction cup in the extreme pressing position.

8. A capping method of the end effector for a robot for capping for a torpedo car according to claim 1, comprising at least the following steps:
1) after the end effector moves to the top of the thermal insulation cover, identifying, by the thermal insulation cover visual system, the center of the thermal insulation cover at the current pick-up position, and feeding back to the robot system, and moving the pickup center of the end effector to be directly above the center of the thermal insulation cover;
2) driving the robot system by using the value fed back by the thermal insulation cover distance detection unit to descend with the end effector and pick up the thermal insulation cover, and in this process, if a measurement deviation of the value fed back by the thermal insulation cover distance detection unit occurs and causes the descent stroke to be too large, thereby endangering the mechanical structure of the end effector, monitoring, by the end effector structure protection unit, a compression amount of the buffer unit at all times, and when the compression amount reaches the critical compression amount, sending out information and driving the robot system to stop descending and lift upwards; and
3. when the end effector moves to the top of the tank opening of the torpedo car, identifying, by the tank opening visual system, a current position of the tank opening of the torpedo car, and feeding back data to the robot system, and after guiding the robot system to move to the top of the tank opening of the torpedo car, completing a capping operation by releasing the thermal insulation cover.

9. The capping method of the end effector of a robot for capping for a torpedo car according to claim 8, wherein the capping method specifically comprises the following steps:
1) after the end effector moves to the top of the thermal insulation cover, activating the thermal insulation cover visual camera, and taking a photo of the thermal insulation cover and identifying to find a center position; thereafter, feeding back, by the thermal insulation cover visual camera, coordinates of the center position of the thermal insulation cover to the robot system;
2) after the robot system moves the end effector to be directly above the thermal insulation cover, executing, by the suction cup, a magnetization instruction; starting to measure, by the laser rangefinder in the end effector, a current distance between the end effector and the thermal insulation cover to be picked up; thereafter, executing, the end effector, a descending instruction according to the feedback value; wherein
during this process, if an error occurs in the feedback value, resulting in an excessive descent stroke, the buffer support rod installed on the suction cup starts to compress; when the compression amount reaches a preset value, the L-shaped stopper installed on the upper end of the buffer support rod bushing triggers the photoelectric sensor signal, and a stop-descending instruction is fed back to the robot system; the picking operation of the thermal insulation cover is completed by default, and the thermal insulation cover is lifted to the process position height;
in this case, the laser rangefinder measures again; because the value fed back by the laser rangefinder remains constant after the picking is successful, the value is used to determine whether the end effector has completed the picking operation of the thermal insulation cover;
3) moving the end effector that picks up the thermal insulation cover to the process position above the tank opening of the torpedo car; then, taking, by the tank opening visual camera, a photo of the tank opening of the torpedo car and identifying to find a center position; then, feeding back, by the tank opening visual camera, coordinates of the center position of the tank opening of the torpedo car to the robot system; after the robot system moves the end effector to the capping process position above the tank opening of the torpedo car, executing, by the suction cup, a demagnetization instruction, so that the thermal insulation cover is released above the tank opening of the torpedo car, thereby completing the capping operation;
4) during the entire operation process, releasing, by the air pipe nozzle connected to the heat dissipation unit, the compressed gas into the end effector, so that the external high-temperature exhaust gas and dust cannot enter the end effector through the holes or gaps, thereby protecting the components.
